(19) United States
(12) Patent Application Publication
(10) Pub. No.: US 2026/0338376 A1
(43) Pub. Date: Oct. 29, 2026

(54) FLAMELESS COMBUSTION OF HYDROCARBONS

(71) Applicant: WTE-TECH B.V., The Hague (NL)

(72) Inventor: Johannus Petrus VAN DEN BERG, Voorburg (NL)

(21) Appl. No.: 19/130,471

(22) PCT Filed: Nov. 3, 2023
(86) PCT No.: PCT/NL2023/050579

§ 371 Date: May 15, 2025

(30) Foreign Application Priority Data
Nov. 18, 2022 (NL) 2033569

(51) Int. Cl. F23G 7/06; B63B 25/12; F23C 9/00; F23D 14/20; F23L 15/00

(52) U.S. Cl. CPC F23G 7/066; B63B 25/12; F23C 9/00; F23D 14/20; F23L 15/00; F23C 2900/99001; F23G 2204/103; F23G 2207/101

(57) ABSTRACT

The present disclosure concerns a method of flameless combustion, comprising: preheating a combustion zone to above 800° C.; maintaining the temperature of the combustion zone at a temperature between 850° C. and 1400° C.; simultaneously injecting an oxidant and a hydrocarbon fuel mixture to the into the combustion zone, wherein the oxidant and the hydrocarbon fuel mixture are injected independently of each other from respective first and second locations; combusting the hydrocarbon fuel mixture without flames; and venting exhaust gasses, wherein the hydrocarbon fuel mixture combusts without flames by maintaining a furnace oxygen concentration of the combustion zone below 12% by volume and maintaining an exhaust gas recirculation rate of from 0 to 0.5. The present disclosure also relates to a furnace (2) for flameless combustion of a hydrocarbon fuel mixture.

### FIELD OF THE INVENTION

The present invention relates to methods for, apparatus and system suitable for the flameless combustion of hydrocarbons.

### BACKGROUND OF THE INVENTION

Hydrocarbons are used as a fuel source throughout the globe. These hydrocarbons are typically sourced from natural sources such as oil fields and gas fields. A significant portion of the extracted hydrocarbons are burnt (flared) at the source of extraction, for instance 80 billion cubic feet of hydrocarbons were either vented or flared in Saudi Arabia in 2020, which is equivalent to approximately 2% of Saudi Arabia's natural gas production. Hydrocarbons are also typically flared during petroleum refining, where flaring is used as a safety release for waste and/or excess gas produced. Flaring excess gas is also conducted during hydrocarbon storage at fuel depots (storing chemicals, petroleum products [such as diesel, petrol, kerosene, heavy ship oil, etc.], biofuels, vegetable oils). During storage, to avoid overpressure build-up of volatile hydrocarbons within the storage tanks, volatile components are extracted and fed to a flare, where they are burnt. Flaring of hydrocarbons also occurs when storage tanks, such as oil depots or LPG tankers, need to be purged before being filled with new hydrocarbons.

Flaring hydrocarbons by traditional means was typically conducted with significant formation of nitrogen oxides, such as nitrogen oxide (NO) and nitrogen dioxide (NO₂). These nitrogen oxides are often abbreviated as NOₓ compounds. NOₓ emissions are involved in the formation of smog, which is formed by reaction of NOₓ compounds with other volatile organic compounds (VOCs) in the atmosphere. NOₓ emissions are also a major source of acid rain. Consequently, it is preferable from both a health and environmental perspective to reduce NOₓ emissions.

Also, the problem of degassing of hydrogen storage tanks of ships (marine vessels) is similar to the problem of flaring hydrocarbons. Both processes involve the release of harmful gases into the atmosphere, which can cause environmental problems.

Degassing a hydrocarbon storage tank involves removing unwanted gases, vapours, volatile substances such VOC (volatile organic compounds) from the interior of a hydrocarbon storage tank. This is usually achieved by heating the hydrocarbon storage tank to evaporate the residual liquid hydrocarbons and venting the vapourised hydrocarbons into the atmosphere. Then flushing the hydrocarbon storage tank with purging gases to displace the unwanted substances, effectively purging the tank of hazardous or unwanted vapours. The unwanted substance/purging gas are typically released into the atmosphere through proper ventilation systems or venting mechanisms.

Flameless combustion is an effective technology that can be used to reduce pollutant emissions from both flaring and degassing, especially NOₓ emissions.

There are three major sources of NOₓ compounds that arise during combustion of hydrocarbons, which are typically referred to as: (i) “prompt NO”; (ii) “fuel NO”; and (iii) “thermal NO”. “Thermal NO”, which arises from the “Zeldovich mechanism”, is the major source of NOₓ emissions from burning clean hydrocarbon sources, such as natural gas.

The three principle reactions that lead to the formation of NOₓ by thermal NO are as follows (in simplified form):

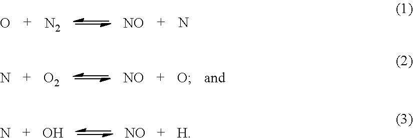

These reactions are only significant at elevated temperatures, typically above 1400° C. Consequently, an early approach to reducing NOₓ emissions from flaring hydrocarbons was to reduce the flame temperature, such as by flame cooling. Alternative approaches involved “flame staging”, in which the reagents are introduced to a primary combustion zone under non-stoichiometric conditions, followed by cooling the resultant combustion products and then finally introduction to a secondary combustion zone. Since the 1989, “flameless combustion”, often referred to as “flameless oxidation” or by the trademark “FLOX”, has been investigated for reduced NOₓ formation. This flameless combustion was achieved with a furnace temperature of approximately 1000° C. and by pre-heating air to approximately 650° C. before introduction to the combustion zone. The characteristics of flameless combustion are that no flame is visible and minimal UV emission. It was found that such a flame could combust clean fuel with minimal NOₓ emissions and less than 1 ppm carbon monoxide content in the exhaust, which is indicative of complete combustion of the fuel. EP 0463218 A1 describes such flameless combustion. Flameless oxidation allows for lower NOₓ generation than combustion staging.

Commercial exploitation of flameless combustion systems has slowly grown since the mid 1990's, being exploited with clean fuels in steel mills (as heat sources for silicon steel strip lines, annealing lines and pickling lines), Stirling engines and gas turbines.

Research has established that homogeneous mixing of the fuel and air/oxidant within the combustion zone are of importance for forming stable flameless oxidation zones, as this avoids “hot spot” formation within the combustion zone where the temperature exceeds 1425° C. at which NOₓ forms rapidly. One way this is achieved is by pre-mixing fuel/air or fuel/oxidant streams before introduction to the oxidation zone/furnace. Whilst this ensures good mixing and thereby more homogeneous combustion, it normally imposes limitations on: (i) what fuels can be used; (ii) what impurities the fuel can comprise; and (iii) what concentrations such fuels can be used to avoid forming mixtures prone to explosion and/or deflagration. For example, (i) if methane is used as the fuel: (ii) the methane fuel may only comprise up to 15% by volume hydrogen; and (iii) methane must be diluted below the lower flammability limit (LFL) of 4.4 volume % in air.

Flameless combustion requires a minimum threshold temperature of around 850° C. Below this temperature incomplete oxidation occurs. Temperatures in the combustion zone above threshold temperature are relatively easy to maintain when clean fuels can be reliably provided at a sufficient rate. However, when fuels are provided with occasional, short periods where insufficient fuel is actually provided to the combustion zone, incomplete combustion occurs. For fuels that cannot be reliably provided at a sufficient rate, by which is meant fuel which can generally be provided at a sufficient rate with short periods of a few seconds where it cannot, this issue can be partially addressed by using a combustion zone filled with a porous matrix of high heat capacity ceramics. The porous matrix retains sufficient heat to restart flameless combustion after the short periods without sufficient fuel provision. The disadvantages of such complicated structures are that they suffer from rapid fouling of the pathways, inability to cope with extended deficiencies in fuel provision, high pressure differences across the matrix and difficulties in maintenance. A further disadvantage is that the high heat capacity of the matrix makes it hard to detect insufficient fuel provision by way of a drop in temperature within the combustion zone. Such systems also employ pre-mixing of fuel and air/oxidant, and so inherit the limitations of such premixing.

### SUMMARY OF THE DISCLOSURE

A goal of the disclosure of the present application is to provide a method, apparatus and a system that allows for flameless combustion of hydrocarbon fuels: (i) whose composition may change over time; (ii) that may comprise high impurity volumes such as hydrogen; (iii) at high volume percent to the combustion zone and/or (iv) at a rate insufficient to maintain spontaneous flameless combustion.

Also, an objective of the flameless combustion method is to achieve both efficient and thorough combustion across a diverse range of combustion gas compositions and energy contents (Lower Heating Value), while concurrently minimizing the formation of NOx.

Another objective of the present invention is to address the environmental challenge associated with the degassing of hydrogen storage tanks intended for hydrocarbon fuel on ships. The present invention seeks to establish a more sustainable and eco-friendly approach to degassing of ships, ensuring that harmful emissions are effectively contained and mitigated.

Further, another object of the invention is to provide a compact flameless combustion apparatus that can be movable, i.e. the capability of the flameless combustion apparatus or system to be easily transported and used in various locations.

In view of the above discussion, a first aspect of the present disclosure relates to a method of flameless combustion, comprising:
(i) preheating a combustion zone to above 800° C.;
(ii) maintaining the temperature of the combustion zone at a temperature between 850° C. and 1400° C.;
(iii) simultaneously injecting an oxidant and a hydrocarbon fuel mixture into the combustion zone, wherein the oxidant and the hydrocarbon fuel mixture are injected independently of each other from respective first and second locations
(iv) combusting the hydrocarbon fuel mixture without flames; and
(v) venting exhaust gasses,
wherein the hydrocarbon fuel mixture combusts without flames by maintaining a furnace oxygen concentration of the combustion zone below 12% by volume and maintaining an exhaust gas recirculation rate of from 0 to 0.5.

A second aspect of the present disclosure relates to a flameless combustion apparatus suitable for the method of flameless combustion of the previous aspect, comprising:
a furnace comprising a combustion zone;
at least one FLOX burner, the FLOX burner comprising a first injection port, the first injection port comprising a first nozzle configured to allow injection of a first hydrocarbon fuel mixture and a second nozzle configured to allow injection of an oxidant;
at least one start-up burner capable of operating under FLOX and flame combustion conditions comprising a second injection port, the second injection port comprising a third nozzle configured to allow injection of a first ancillary (auxiliary) fuel and a fourth nozzle configured to allow injection of an oxidant;
a means of measuring a combustion temperature;
an exhaust port (stack);
wherein the first and second nozzles are arranged in parallel so as to allow provision of the first hydrocarbon fuel mixture and oxidant to the FLOX burner; and
wherein the third and fourth nozzles are arranged in parallel so as to allow provision of the first ancillary (auxiliary) fuel mixture and oxidant to the start-up burner.

A third aspect of the present disclosure relates to a method for combusting Boil-Off Gas (BOG) comprising hydrocarbons, the method comprising:
collecting BOG comprising at least one hydrocarbon from at least one hydrocarbon storage tank;
delivering the collected BOG to a combustion apparatus suitable for performing the method of the first aspect; and
combusting the BOG under flameless conditions according to a method according to any embodiment of the first aspect.

A fourth aspect of the present disclosure relates to a method for combusting Residual Gas and/or Liquid (RGL) comprising hydrocarbons, the method comprising:
bringing a hydrocarbon storage tank into fluid communication with a combustion apparatus suitable for performing the method of any embodiment according to the first aspect;
delivering a gas comprising residual gas and/or liquid from the hydrocarbon storage tank to the combustion apparatus;
when the temperature of the combustion zone of the combustion apparatus exceeds 850° C., combusting the residual gas and/or liquid under flameless conditions according to a method according to any embodiment according to the first aspect;
controlling the supply of residual gas and/or liquid to the combustion zone to maintain a temperature above 850° C. so as to maintain flameless combustion in the combustion zone
when the maximal supply of residual gas and/or liquid to the combustion zone of the combustion apparatus becomes insufficient to maintain a temperature of above 850° C., providing auxiliary fuel to the combustion zone of the combustion apparatus and combusting both: (i) the auxiliary fuel; and (ii) the residual gas and/or liquid under flameless conditions according to a method according to any embodiment of the first aspect.

A fifth aspect of the present disclosure relates to a system suitable for combusting Residual Gas and/or Liquid (RGL) comprising:
at least one hydrocarbon storage tank; and
a combustion apparatus suitable for performing the method of any embodiment of the first aspect,
wherein the hydrocarbon storage tank(s) are connected to the combustion apparatus by means allowing the hydrocarbon storage tanks to be brought into fluid communication with the combustion apparatus.

A sixth aspect of the present disclosure relates to method for degassing a hydrocarbon storage tank, wherein the method comprises the following steps:
pumping out any liquid from the hydrocarbon storage tank until less than 5% of the hydrocarbon storage tank by volume is filled with hydrocarbon liquid;
bring hydrocarbon storage tank into liquid communication with an intermediate storage tank;
vaporizing residual hydrocarbon liquid in the hydrocarbon storage tank;
allowing vapourised hydrocarbon to move from the hydrocarbon storage tank to the intermediate storage tank;
optionally condensing and/or compressing vapourised hydrocarbon in the intermediate storage tank;
purging the hydrocarbon storage tank with an inert gas;
delivering the purging gas from the hydrocarbon storage tank to: (i) the storage tank, and/or (ii) a combustion apparatus suitable for performing the method of any embodiment according to the first aspect;
delivering at least some of the purging gas comprising the hydrocarbon to the combustion apparatus;
when the temperature of the apparatus exceeds 850° C., combusting the gas delivered to the apparatus under flameless conditions according to a method according to any embodiment according to the first aspect;
when the temperature of the apparatus is below 850° C., providing auxiliary fuel as a co-feed to the purging gas comprising the hydrocarbon and combusting the auxiliary fuel and gas delivered to the apparatus under flameless conditions according to a method according to any embodiment according to the first aspect.

A seventh aspect of the present disclosure relates to a system suitable for degassing a hydrocarbon storage tank of a ship comprising:
an intermediate storage tank;
a combustion apparatus suitable for performing the method of any aspect according to the first aspect;
means to bring the hydrocarbon storage tank of a ship into fluid communication with the intermediate storage tank; and
means to bring the hydrocarbon storage tank of a ship into fluid communication with the combustion apparatus and/or means to bring the intermediate storage tank of a ship into fluid communication with the combustion apparatus.

### SHORT DESCRIPTION OF THE FIGURES

FIG. 1 depicts a schematic lay out for a method for combusting Boil-Off Gas (BOG) comprising hydrocarbons for three connected storage tanks.

FIG. 2 depicts a representative off gas rate for a number of connected storage tanks over a year.

FIG. 3 depicts an apparatus according to the second aspect of the invention.

FIG. 4 depicts the variation of combustion zone temperature and O₂ concentration by volume versus off gas hydrocarbon fuel mixture flow variation from 50 to 910 kg/hr.

FIG. 5 depicts the simulated variation of combustion zone temperature and O₂ concentration by volume under simulated drop out of hydrocarbon fuel mixture off gas flow and incoming auxiliary LPG fuel gas.

FIG. 6: depicts the simulated variation of combustion zone temperature and O₂ concentration by volume versus off gas hydrocarbon fuel mixture upon drop out of hydrocarbon fuel mixture off gas flow and incoming auxiliary LPG fuel gas.

### DEFINITIONS AND ABBREVIATIONS

Recirculation rate, Kᵥ. The recirculation rate, Kᵥ, is defined as follows:

Kᵥ=M_{E}/(M_{F}+M_{A}),

where: (i) M_{E} is the mass of recirculated exhaust gas; (ii) M_{F} is the mass of the hydrocarbon fuel (hydrocarbon fuel mixture); and (iii) M_{A} is the mass of combustion air. The recirculation rate is used to calculate the recirculation rate of recirculated exhaust gas in relation to the masses of hydrocarbon fuel (hydrocarbon fuel mixture) and combustion air. Recirculating the exhaust gases can help control the combustion temperature and dilute hydrocarbon concentrations.

### DETAILED DESCRIPTION OF THE INVENTION

The system, method and apparatus of the present invention is

A first aspect of the present disclosure relates to a method of flameless combustion, comprising:
(i) preheating a combustion zone to above 800° C.;
(ii) maintaining the temperature of the combustion zone at a temperature between 850° C. and 1400° C.;
(iii) simultaneously injecting an oxidant and a hydrocarbon fuel mixture into the combustion zone, wherein the oxidant and the hydrocarbon fuel mixture are injected independently of each other from respective first and second locations;
(iv) combusting the hydrocarbon fuel mixture without flames; and
(v) venting exhaust gasses,
wherein the hydrocarbon fuel mixture combusts without flames by maintaining a furnace oxygen concentration of the combustion zone below 12% by volume and maintaining an exhaust gas recirculation rate of from 0 to 0.5.

The method above helps lower combustion temperatures and reduce the formation of NOₓ to levels well below regulatory thresholds.

The oxidant and the hydrocarbon fuel mixture (hydrocarbon fuel) are separately fed to the combustion zone of the combustion chamber in the furnace There is no mixing before the hydrocarbon fuel mixture and oxidizer are fully mixed in the combustion chamber, including the recirculating exhaust gas. The terms “hydrocarbon fuel” and “hydrocarbon fuel mixture” are used interchangeably.

In a preferred embodiment, the method of the first aspect can comprises a first step of pre-heating the combustion zone to above 800° C. using an auxiliary fuel (e.g. natural gas) in order to ensure optimal conditions for combustion and to reach a temperature level at which the autooxidation of the hydrocarbon fuel will start and flameless combustion conditions are established

The method of flameless combustion is operated under continuous operation, where the hydrocarbon oxidation takes place under flameless conditions.

The method of the first aspect can comprise an additional step of providing an auxiliary fuel during instances of rapid decrease in hydrocarbon fuel mixture levels (reduction in the concentration of hydrocarbon in the fuel mixture present or reduction of the total flow of purge (purging) gas with hydrocarbons) or complete hydrocarbon fuel mixture flow cessation aimed at effectively mitigating temperature fluctuations and ensuring stable thermal conditions. The swift activation of the auxiliary fuel supply is designed to prevent the combustion process from extinguishing completely due to the sudden decrease in hydrocarbon fuel mixture supply. By providing a short injection of auxiliary fuel, the combustion temperature can be quickly raised back to operational levels, ensuring a stable and continuous combustion process.

Furthermore, precise control of the exhaust gas recirculation rate (ranging from 0 to 0.5) serves to effectively dilute the concentration of hydrocarbons within the combustion chamber. When the rate of exhaust gas recirculation exceeds 0.5, it leads to an increased total gas volume in the system. This, in turn, elevates turbulence levels, necessitating the deployment of a larger and more cumbersome flameless combustion apparatus, which is undesirable given that one of the aims of the present invention is to maintain a compact design suitable for movable (transportable) applications.

One advantage of this method is that it allows for flameless combustion of hydrocarbon fuel mixtures that have very high operational turndown ratios. Therefore, the method can be suitably used for flameless combustion of hydrocarbon fuel mixtures that: (i) vary over time in terms of hydrocarbon composition; (ii) flow rate/mass transfer; and/or (iii) vary over time in terms of individual hydrocarbon concentration. Varying hydrocarbon composition, flow rate and/or hydrocarbon concentration typically results in changes in different combustion enthalpies and/or combustion entropies. This advantageously allows for flameless combustion of hydrocarbon fuel mixtures without analysis of exact hydrocarbon composition and concentration to operate, such as boil-off gas.

A further advantage of the present method is that it generates less noise than traditional flaring methods.

Yet another advantage of the present method is that it operates at lower oxygen concentrations (below 12%) in the combustion chamber than known flameless oxidation systems. This advantageously allows for significantly higher concentrations of hydrocarbons in the hydrocarbon fuel mixture to be safely combusted, in the range of 1.5 to 15% by volume of the fuel mixture, without exceeding the lower explosion limits.

An advantage of simultaneously separately injecting an oxidant and a hydrocarbon fuel mixture into the combustion zone, wherein the oxidant and the hydrocarbon fuel mixture are injected independently of each other from respective first and second locations is that pre-mixing of the hydrocarbon fuel mixture and oxidant can be avoided before introduction to the combustion chamber within the furnace of the flameless combustion apparatus. This advantageously allows for significantly higher concentrations of hydrocarbons in the hydrocarbon fuel mixture to be safely combusted, in the range of 1.5 to 15% by volume of the fuel mixture, without exceeding the lower explosion limits.

Preferably, the method is one in which the oxidant is pre-heated before injection into the combustion zone. This pre-heating of the oxidant advantageously allows yet higher operational turndown ratios to be employed.

Preferably, the method is one in which the hydrocarbon fuel mixture is pre-heated before injection into the combustion zone. This pre-heating of the hydrocarbon fuel mixture advantageously allows yet higher operational turndown ratios to be employed.

Preferably, the method is one wherein the hydrocarbon fuel mixture is selected from a boil-off gas, a residual gas or liquid, a hydrocarbon storage purge gas or any combination thereof.

Preferably, the method is one in which the temperature of the furnace is maintained at a temperature of from 850 to 1200° C. by either:
Introducing cooling air with a temperature of below 40° C. to the furnace; and/or
Introducing an auxiliary fuel to the furnace.

One advantage of this preferable embodiment is that greater control of the temperature in the combustion zone can be obtained by adding cool (<40° C.) air and/or adding auxiliary fuel to the furnace.

More preferably, the auxiliary fuel is selected from propane, Liquefied Petroleum Gas (LPG), Natural Gas (NG), refinery fuel gas or any combination thereof.

Preferably, the method is one wherein the furnace oxygen concentration is maintained at from 3% to 12% by volume, preferably from 3% to 10% by volume. The hydrocarbon fuel mixture (or hydrocarbon fuel) can be blended with the oxidant, and the exhaust gas, in a manner that maintains the oxygen concentration within the furnace between 3% to 10% by volume.

Maintaining an oxygen concentration above 3% by volume advantageously minimizes CO formation.

Preferably, the method is one wherein the furnace temperature is maintained at a temperature of from 800-1400° C., preferably of from 850 to 1200° C., more preferably of from 900-1100° C.

Preferably, the method is one wherein the method comprises a first step of pre-heating the combustion zone to above 800° C. using an auxiliary fuel.

Preferably, the method is one, wherein the auxiliary fuel is selected from methane, ethane, propane, butane, natural gas, any ignitable other hydrocarbon or flammable gaseous feed (e.g. H2) or any combination thereof, more preferably selected from methane, ethane, propane, butane, natural gas, any other hydrocarbon, hydrogen or any combination thereof, most preferably selected from methane, ethane, propane, butane.

Preferably, the method is one wherein the (pre-heated) oxidant is introduced to the oxidation zone at a velocity of at least 40 m/s, preferably at a velocity of at least 50 m/s.

Preferably, the method is one wherein the first hydrocarbon fuel mixture is introduced to the oxidation zone at a velocity of at least 40 m/s, preferably at least 50 m/s, more preferably at least 80 m/s,

High velocity nozzles for the hydrocarbon fuel mixture and the oxidant are used to ensure instantaneous mixing of both combustion components and recirculating exhaust gas upon injection into the combustion chamber (high turbulent conditions), resulting in complete combustion of the hydrocarbon fuel mixture.

Preferably, the method is one wherein the first hydrocarbon fuel mixture is provided to the combustion zone at 0.8 to 50 megajoules per normal cubic metre (MJ/Nm³), preferably 1.0 to 30 MJ/Nm³, more preferably 1.5 to 20 MJ/Nm³,

Preferably, the method is one wherein the first hydrocarbon fuel mixture is a hydrocarbon off-gas.

Preferably, the method is one wherein if the first hydrocarbon fuel mixture comprises hydrogen, the method is designed to effectively handle a hydrocarbon fuel mixture containing hydrogen without compromising the safety due hydrogen's flammability characteristics. Preferably, the hydrocarbon fuel mixture is introduced at a flow rate of at least 50 m/s. This may be measured using a dP measurement over the injector. This advantageously allows for minimizing the risk of flare-backs.

A second aspect of the present disclosure relates to a flameless combustion apparatus suitable for the method of flameless combustion of the previous aspect, comprising:
a furnace comprising a combustion zone;
at least one FLOX burner, the FLOX burner comprising a first injection port comprising a first nozzle configured to allow injection of a first hydrocarbon fuel mixture and a second nozzle configured to allow injection of an oxidant;
at least one start-up burner capable of operating under FLOX and flame combustion conditions comprising a second injection port, the second injection port comprising a third nozzle configured to allow injection of a first auxiliary (ancillary) fuel and a fourth nozzle configured to allow injection of an oxidant;
a means of measuring a combustion temperature; and
an exhaust port (stack);
wherein the first and second nozzles are arranged in parallel so as to allow provision of the first hydrocarbon fuel mixture and oxidant to the FLOX burner; and
wherein the third and fourth nozzles are arranged in parallel so as to allow provision of the first auxiliary (ancillary) fuel mixture and oxidant to the start-up burner.

Preferably, the furnace of the flameless combustion apparatus comprises a combustion chamber with the combustion zone. The combustion zone refers to the specific region within the combustion chamber in the furnace where the flameless combustion reactions occur.

The terms “ancillary” or “auxiliary” are used herein interchangeably.

The apparatus according to the second aspect may advantageously allow for the method of the first aspect to be performed, with all attendant advantages.

The configuration of injection ports allows the first hydrocarbon fuel mixture and first auxiliary fuel to be provided to separate burners (FLOX burner and start-up burner) capable of FLOX combustion. This configuration advantageously allows the apparatus to maintain an operational temperature that minimizes NOₓ emissions despite low hydrocarbon concentrations in the first hydrocarbon fuel mixture. Therefore, the configuration allows the apparatus to possess a high turndown ratio. This configuration also advantageously allows the apparatus to maintain an operational temperature that minimizes NOₓ emissions in the case of temporary interruption of first hydrocarbon fuel mixture provision. This configuration advantageously allows for the omission of thermal buffering.

The independent injection of feed components (comprising the oxidant and hydrocarbon fuel mixture) at minimum gas velocity results in intensive mixing at the furnace inlet upon entry into the combustion chamber and this intensive mixing ensures effective and homogenous oxidation of all available hydrocarbons. Minimum gas rates at the furnace inlet are important to meet the mixing requirements, because they affect the rate at which the fuel and air mix. The minimum gas rates should be high enough to ensure turbulent conditions at the point of injection such that the fuel and air mix completely within the combustion chamber. If the gas rates are too low, the fuel and air will not mix properly and combustion will not be efficient. The term furnace inlet refers to the precise point within the flameless combustion apparatus where the oxidant and hydrocarbon fuel mixture come together before entering the combustion chamber. The first injection port is a nozzle that is configured to allow injection of a first hydrocarbon fuel mixture and a second nozzle configured to allow injection of an oxidant. The two nozzles are located such that the hydrocarbon fuel mixture and the oxidant can mix intimately. In the combustion chamber, a homogeneous oxidation reaction takes place in the gas phase, utilizing the full volume of the combustion chamber. Non-hydrocarbons are fully oxidized (S, N, etc). Wide range of hydrocarbons can be applied;

Notably, the combustion chamber of the furnace has a compact design and functions at reduced oxygen concentrations (ranging from 3% to 12% by volume, more preferably 3-10% by volume. Moreover, the reduced levels of oxidant also strengthens the flameless combustion apparatus' ability to ensure safety, protect against risks, and maintain optimal operation. Thus, the method and apparatus of the present invention ensures a complete hydrocarbon combustion, full oxidation of pollutant components (S, N and other), while achieving low NOx (nitrogen oxides) formation.

The configuration of first and second injection ports are arranged in parallel advantageously allows for the apparatus to operate without pre-mixing of the first hydrocarbon fuel mixture before introduction to the apparatus.

Preferably, the flames combustion apparatus can be designed to be movable such that it can be transported from one place to another.

Preferably, the flameless combustion apparatus is compact as it is designed with transportability in mind, ensuring it can be efficiently deployed wherever it is needed and also the apparatus is designed to fit on specialized transport equipment, where for example the combustion chamber of the furnace can have dimensions of 5 meters in length, 2 meters in height, and 2 meters in width.

Preferably, the flameless combustion apparatus has a plurality of FLOX burner units. This advantageously allows the flameless combustion apparatus to possess an even higher turndown ratio.

Preferably, the flameless combustion apparatus has a means of measuring the pressure within the combustion zone.

Preferably, the flameless combustion apparatus comprises a means of measuring the O₂ concentration within the combustion zone. Such means advantageously allows the flameless combustion apparatus to be operated with greater combustion control.

Preferably, the flameless combustion apparatus comprise a heat exchanger. More preferably, the heat exchanger is configured to allow heat to be transferred from the exhaust to: (i) the hydrocarbon fuel mixture; (ii) the oxidant; (iii) the auxiliary (ancillary) fuel; (iv) generate steam for energy combustion; and/or (v) any combination thereof. This advantageously allows for greater fuel efficiency when the apparatus is operated with low hydrocarbon concentration in the hydrocarbon fuel mixture. This also advantageously allows for a lower exhaust temperature, which may be required for safe operation in areas at risk of hydrocarbon leaks, such as LPG tanks or on LPG tankers.

Preferably, the flameless combustion apparatus comprises a start-up burner. The start-up burner is configured to allow the combustion chamber to be brought up to a temperature of at least 850° C. More preferably, the flameless combustion apparatus comprises start-up burner using a start-up gas selected from propane, Liquefied Petroleum Gas (LPG), Natural Gas (NG), a refinery fuel gas or any combined fuel thereof.

In a preferred embodiment, the flameless combustion apparatus can be configured to perform the method of flameless combustion in accordance with the first aspect.

A third aspect of the present disclosure relates to a method for combusting Boil-Off Gas (BOG) comprising hydrocarbons, the method comprising:
collecting BOG comprising at least one hydrocarbon from at least one hydrocarbon storage tank;
delivering the collected BOG to a combustion apparatus, preferably a flameless combustion apparatus, suitable for performing the method of the first aspect; and
combusting the BOG under flameless conditions according to a method according to any embodiment of the first aspect.

In a preferred embodiment, the combustion apparatus for collecting boil-off gas (BOG) according to the third aspect can be a flameless combustion apparatus configured to facilitate and enable flameless combustion according to the method of flameless combustion of the first aspect.

A fourth aspect of the present disclosure relates to a method for combusting Residual Gas and/or Liquid (RGL) comprising hydrocarbons, the method comprising:
bringing a hydrocarbon storage tank into fluid communication with a combustion apparatus, preferably flameless combustion apparatus, suitable for performing the method of any embodiment according to the first aspect;
delivering a gas comprising residual gas and/or liquid from the hydrocarbon storage tank to the combustion apparatus;
when the temperature of the combustion zone of the combustion apparatus exceeds 850° C., combusting the residual gas and/or liquid under flameless conditions according to a method according to any embodiment according to the first aspect;
controlling the supply of residual gas and/or liquid to the combustion zone to maintain a temperature above 850° C. so as to maintain flameless combustion in the combustion zone
when the maximal supply of residual gas and/or liquid to the combustion zone of the combustion apparatus becomes insufficient to maintain a temperature of above 850° C., providing auxiliary fuel to the combustion zone of the combustion apparatus and combusting both: (i) the auxiliary fuel; and (ii) the residual gas and/or liquid under flameless conditions according to a method according to any embodiment of the first aspect.

Preferably, the method comprises the additional step of:
purging the storage tank with an inert gas and delivering the hydrocarbon comprising purging gas to the combustion apparatus;
when the temperature of the combustion zone of the combustion apparatus exceeds 850° C., introducing the hydrocarbon comprising purging gas to the combustion zone to combust the hydrocarbons within the purging gas under flameless conditions according to a method according any embodiment of the first aspect;
controlling the supply of hydrocarbon comprising purging gas to the combustion zone to maintain a temperature above 850° C. so as to maintain flameless combustion in the combustion zone; and
when the maximal supply of purging gas to the combustion zone of the combustion apparatus becomes insufficient to maintain a temperature of above 850° C., providing auxiliary fuel to the combustion zone of the combustion apparatus and combusting both: (i) the auxiliary fuel; and (ii) the hydrocarbons of the purging gas under flameless conditions according to method according to the first aspect.

The term RGL (Residual Gas and/or Liquid) refers to a mixture that contains both gases and liquids remaining within a system, container, hydrocarbon storage tank, or process after primary extraction or separation. In the context of hydrocarbons, RGL specifically indicates a combination of gases and/or liquids that consist of hydrocarbon compounds.

In a preferred embodiment, the combustion apparatus according to the fourth aspect of the invention can be a flameless combustion apparatus as described in accordance with the second aspect of the invention, where the flameless combustion apparatus is configured to facilitate and enable flameless combustion in accordance with the method of the first aspect.

Preferably, the method is conducted with the proviso that if flameless combustion is not possible, the purging gas is passed through a flare.

Preferably, the purging gas is selected from nitrogen, argon or a mixture thereof.

A fifth aspect of the present disclosure relates to a system suitable for combusting Residual Gas and/or Liquid (RGL) comprising:
at least one hydrocarbon storage tank; and
a combustion apparatus, preferably a flameless combustion apparatus, suitable for performing the method of any embodiment of the first aspect,
wherein the hydrocarbon storage tank(s) are connected to the combustion apparatus by means allowing the hydrocarbon storage tanks to be brought into fluid communication with the combustion apparatus.

A sixth aspect of the present disclosure relates to a method for degassing a hydrocarbon storage tank within the system for flameless combustion according to the eight aspect of the present invention, wherein the method comprises the following steps:
pumping out any liquid from-the hydrocarbon storage tank until less than 5% of the hydrocarbon storage tank by volume is filled with hydrocarbon liquid;
bringing the hydrocarbon storage tank of vessel into fluid communication with the intermediate storage tank;
vaporizing residual hydrocarbon liquid in the hydrocarbon storage tank;
allowing vapourised hydrocarbon to move from the hydrocarbon storage tank to the intermediate storage tank;
optionally condensing and/or compressing vapourised hydrocarbon in the intermediate storage tank;
delivering at least a primary portion of the vaporized, condensed, and/or compressed hydrocarbon from the intermediate storage tank to a flameless combustion apparatus configured to perform the method of flameless combustion according to the first aspect of the invention, and/or facilitating an export of a secondary portion of the condensed hydrocarbon,
purging the hydrocarbon storage tank subsequent to removal of the residual hydrocarbon liquid in the preceding steps with an inert gas, such as nitrogen, argon, or a mixture thereof;
delivering the hydrocarbon comprising purging gas from the hydrocarbon storage tank to: (i) the intermediate storage tank, and/or (ii) a flameless combustion apparatus adapted to perform the method according to the first aspect;
delivering at least some of the purging gas comprising the hydrocarbon to the flameless combustion apparatus;
when the temperature of the combustion zone of the flameless combustion apparatus exceeds 850° C., combusting the gas delivered to the apparatus under flameless conditions according to a method according to any embodiment according to the first aspect;
controlling the supply of hydrocarbon comprising purging gas to the combustion zone to maintain a temperature above 850° C. so as to maintain flameless combustion in the combustion zone; and
when the maximal supply of purging gas to the combustion zone of the flameless combustion apparatus becomes insufficient to maintain a temperature of above 850° C., providing auxiliary fuel to the combustion zone of the combustion apparatus and combusting both: (i) the auxiliary fuel; and (ii) the hydrocarbons of the purging gas under flameless conditions according to method according to the first aspect.

The above method for degassing can be used for loading/discharging or cleaning of the hydrocarbon storage tank in a ship.

The term “hydrocarbon comprising purging gas” refers to a hydrocarbon-rich purging gas, or more specifically to the mixture of gases that are removed from the hydrocarbon storage tank during the degassing process including the inert gas used for purging.

In a preferred embodiment, the combustion apparatus according to the sixth aspect of the invention can be a flameless combustion apparatus as described in accordance with the second aspect of the invention, where the flameless combustion apparatus is configured to facilitate and enable flameless combustion in accordance with the method of the first aspect.

In the sixth aspect of the present invention, the hydrocarbon storage tank is emptied and any residual hydrocarbon liquid that couldn't be extracted is vaporized, for example by heating. The vapourised hydrocarbon liquid is moved to an intermediate storage tank, potentially condensed or compressed and subsequently stored in the intermediate storage tank. The condensed hydrocarbon can be fed to the flameless combustion apparatus or utilised for other purposes. During an additional purging step, the hydrocarbon storage tank is purged with an inert gas i.e. the purging gas. Then, the hydrocarbon-rich purging gas is not simply released into the atmosphere. Instead, it's directed to the intermediate storage tank and/or the to the flameless combustion apparatus. Thus, the present invention eliminates the need for venting, which traditionally releases potentially harmful emissions into the environment.

In a preferred embodiment, the hydrocarbon storage tank can have a volume between 4000-30000 m3, more preferably between 4000-10000 m3.

The present aspect of the invention is particularly advantageous for removing residual hydrocarbons from the purging gas as it can cope with the extreme changes in hydrocarbon content of the purging gas. Purging hydrocarbon storage tanks with inert gases typically result in a purge gas that initially contains a high hydrocarbon content, dominated by highly volatile hydrocarbons. As the purging process continues, the overall hydrocarbon content diminishes over time and composition becomes increasingly dominated by less volatile hydrocarbons. The present aspect advantageously allows nitrogen to be used as the purging gas without excessive NOₓ emissions. The present aspect also advantageously obviates the need for real-time analysis of overall hydrocarbon concentration and/or hydrocarbon composition in the purge gas. Preferably the purging gas is selected from nitrogen, argon or a mixture thereof, more preferably, the purging gas is nitrogen.

Further, the method of degassing involves capturing and combusting of hydrocarbons in a controlled manner. This can significantly reduce the release of volatile organic compounds (VOCs) and other harmful pollutants into the atmosphere.

A seventh aspect of the present disclosure relates to a system suitable for degassing a hydrocarbon storage tank comprising:
an intermediate storage tank;
a combustion apparatus, preferably a flameless combustion apparatus, suitable for performing the method of any aspect according to the first aspect;
means to bring the hydrocarbon storage tank into fluid communication with the intermediate storage tank; and
means to bring the hydrocarbon storage tank into fluid communication with the combustion apparatus and/or means to bring the intermediate storage tank into fluid communication with the combustion apparatus.
In a preferred embodiment, the combustion apparatus according to the seventh aspect of the invention can be a flameless combustion apparatus as described in accordance with the second aspect of the invention, where the flameless combustion apparatus is configured to facilitate and enable flameless combustion in accordance with the method of the first aspect.
An eight aspect of the present disclosure relates to a system for flameless combustion, comprising at least one hydrocarbon storage tank and a flameless combustion apparatus according to the second aspect of the invention, the flameless combustion apparatus comprising
a furnace with a combustion chamber and a combustion zone;
at least one FLOX burner, the FLOX burner comprising a first injection port, the first injection port comprising a first nozzle configured to allow injection of a first hydrocarbon fuel mixture and a second nozzle configured to allow injection of an oxidant;
at least one start-up burner capable of operating under FLOX and Flame combustion conditions comprising a second injection port, the second injection port comprising a third nozzle configured to allow injection of a first auxiliary fuel and a fourth nozzle configured to allow injection of an oxidant;
a means of measuring a combustion temperature; and
an exhaust port;
wherein the first and second nozzles are arranged in parallel so as to allow provision of the first hydrocarbon fuel mixture and oxidant to the FLOX burner; and
wherein the third and fourth nozzles are arranged in parallel so as to allow provision of the first auxiliary fuel and optionally oxidant to a start-up burner,
wherein the at least one hydrocarbon storage tank is connected to the flameless combustion apparatus.
In an embodiment, the second injection port and furnace of the system for flameless combustion are configured to allow flameless combustion of the first auxiliary fuel with an exhaust gas recirculation rate of from 0 to 0.5.

Further, the flameless combustion apparatus of the system for flameless combustion is configured to perform the method of flameless combustion according to the method of flameless combustion of the first aspect of the invention.

Further, the system for flameless combustion can comprise an intermediate storage tank and means to bring the hydrocarbon storage tank into a fluid communication with the intermediate storage tank. Also, the system for flameless combustion can comprise means to bring the hydrocarbon storage tank into fluid communication with the flameless combustion apparatus and/or means to bring the intermediate storage tank into fluid communication with the flameless combustion apparatus.

The system for flameless combustion can be used for a ship degassing i.e. a process of removing residual hydrocarbon gases from the cargo tanks (hydrocarbon storage tanks). Thus, in a preferred embodiment, the hydrocarbon storage tank can be located within a ship.

Further, the flameless combustion apparatus and/or the system for flameless combustion can be designed to be movable and can be transported from one place to another. The system for flameless combustion can be employed on different ships, making it adaptable to different vessels and locations where ship degassing is necessary. It's designed with portability in mind, ensuring it can be efficiently deployed wherever it is needed.

In addition, the system for flameless combustion can be used for flameless combustion of Residual gas and/or Liquid (RGL).

### DETAILED DESCRIPTION OF THE FIGURES

The disclosure will now be discussed with reference to the figures, which show preferred exemplary embodiments of the subject disclosure.

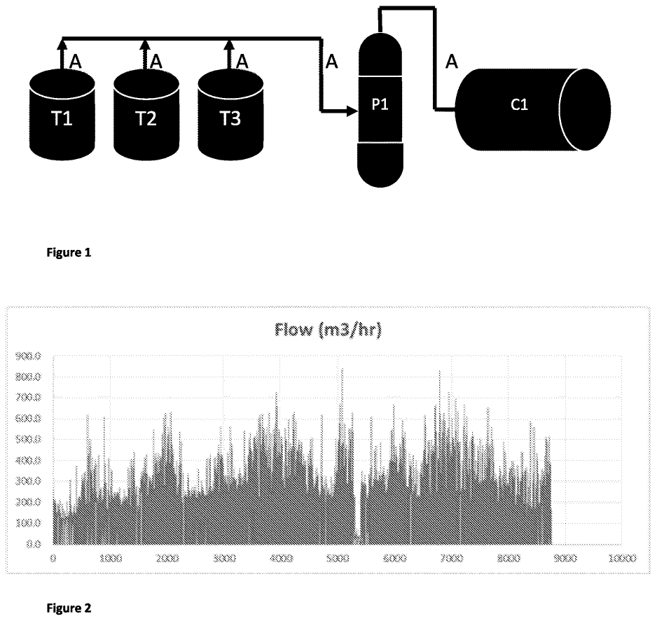

FIG. 1 depicts a schematic lay out for a method for combusting Boil-Off Gas (BOG) comprising hydrocarbons. The term Boil-off gas (BOG) refers to the vaporization of liquefied gases, such as liquefied natural gas (LNG) or liquefied petroleum gas (LPG), or liquefied ethylene gas (LEG), due to changes in temperature and pressure. In this example there are three hydrocarbon storage tanks [T1, T2 and T3]. In the depicted method, BOG comprising at least one hydrocarbon is collected from at least one of the hydrocarbon storage tanks [T1, T2 and/or T3]. This is depicted by arrows [A1, A2 and/or A3]. The BOG comprising at least one hydrocarbon may be collected from one, two or all of the tanks simultaneously or sequentially. The BOG comprising at least one hydrocarbon is optionally passed [A4] through a pre-treatment plant [P1], such as an AC filter, which allows: (i) residual H₂S and/or (ii) condensed hydrocarbons to be fully or partially removed from the BOG. The collected BOG comprising at least one hydrocarbon is delivered to a combustion apparatus, more preferably a flameless combustion apparatus, suitable for performing the method of the first aspect [C1]. This is depicted by the arrow [A5]. The BOG is combusted under flameless conditions according to a the method for flameless combustion according to any embodiment of the first aspect.

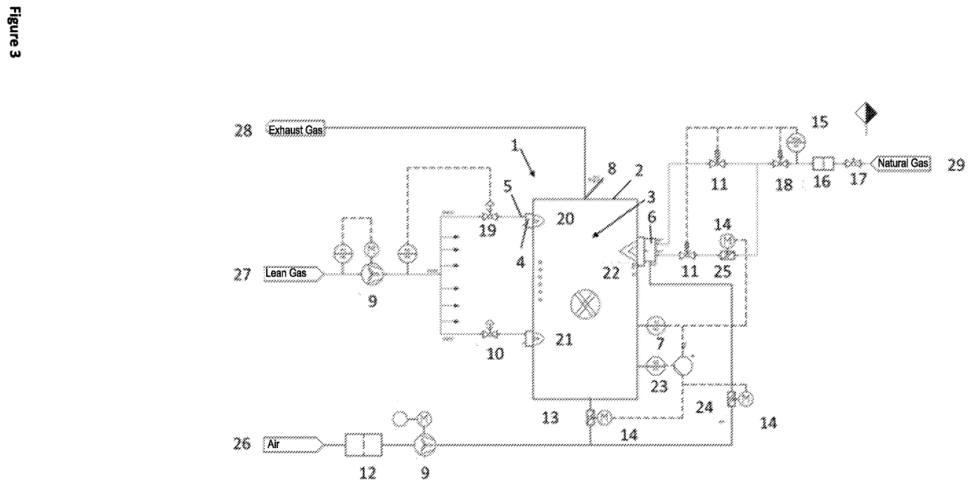

FIG. 2 depicts a representative off gas rate for a number of connected storage tanks over a year. The term “off gas” refers to gases that are released as waste or secondary products during various operations. The typical flow pattern is shown for 8800 hours (flow rate on the y-axis, with graduations in 100 m³/hour, time on the x-axis, with graduations in 1000 hours), with every 4 hours corresponding to a data point. The average flow is estimated at 145.2 m³/hour and the maximum flow-rate was estimated at 839 m³/hour.

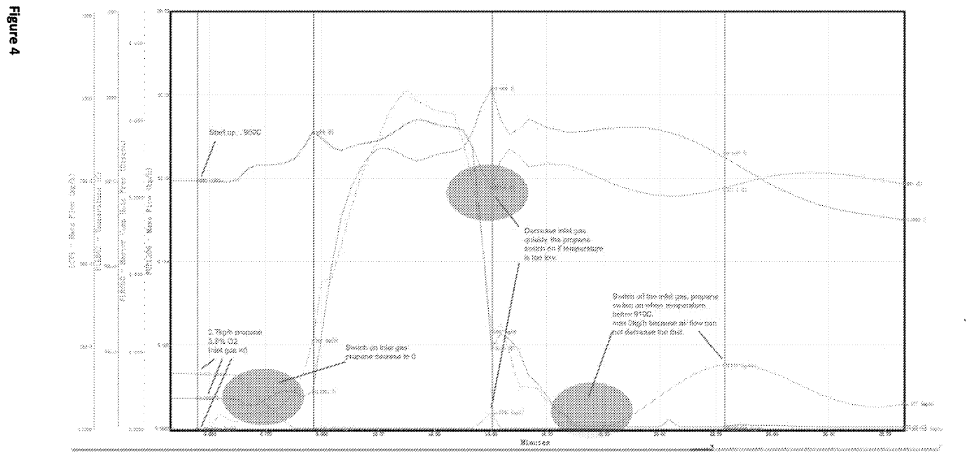

FIG. 3 depicts a non-limiting example of the line-up (PFD) of an apparatus according to the second aspect of the invention. In this non-limiting example, the furnace (2) of the flameless combustion apparatus comprises-a combustion chamber that is a square combustion chamber with a length of 5 m, a height of 2 m and a width of 2 m. The combustion chamber is designed with one start-up burner, eight high velocity vent gas injectors and four probes for (cooling) air injection. The probes are devices used to introduce (cooler) air into the combustion chamber. Two LPG or propane probes will be installed for injection of auxiliary fuel.

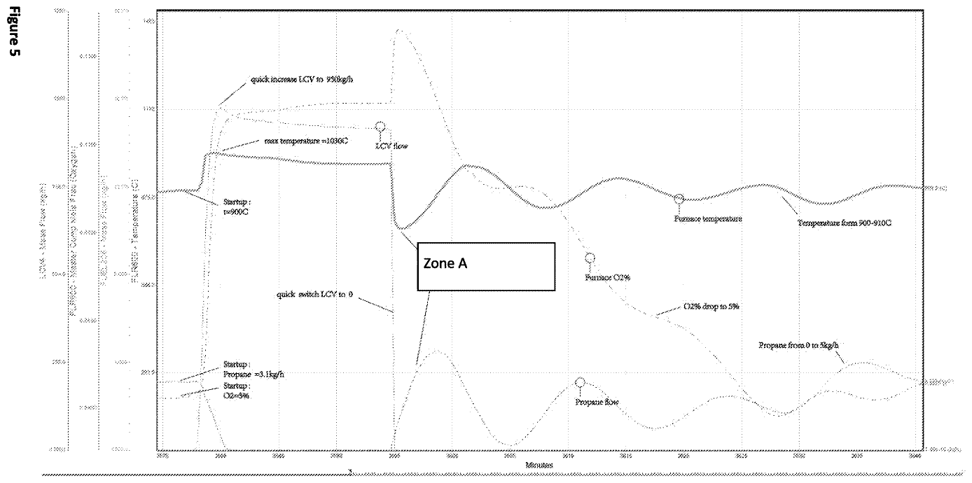

FIG. 4 depicts the simulated variation of combustion zone temperature and O₂ concentration by volume versus off gas hydrocarbon fuel mixture flow variation from 50 to 910 kg/hr for unit start-up conditions.

The x-axis is time in minutes, from 2 to 29 minutes in graduations of 4 minutes. There are four y-axes, which read from left to right, are as follows:
1. hydrocarbon fuel (hydrocarbon fuel mixture) mass flow (“LCV4” in kg/h), 0 to 1250 kg/h in graduations of 250 kg/h;
2. Temperature of the combustion zone (° C.), 0 to 1500° C., in graduations of 300° C.;
3. Computed mole fraction O₂ (in %) from 0.0250 to 0.160, in graduations of 0.0250; and
4. Auxiliary fuel mass flow (propane, denoted “Fuel206”, in kg/h), from 0 to 20 kg/h, in graduations of 4 kg/h.

The lines, starting from top to bottom as they intersect the y-axis, are as follows:
a. Temperature, with a starting value of 900° C.;
b. Auxiliary fuel flow rate, with an initial value of 2.7 kg/h;
c. Computed mole fraction O₂, with an initial value of 3.5%; and
d. Hydrocarbon fuel (hydrocarbon fuel mixture) mass flow, with an initial value of 0.

In the first shaded zone (reading from left to right), the hydrocarbon fuel (hydrocarbon fuel mixture) starts to be provided to the combustion zone in the furnace, and the amount of auxiliary fuel provided for pre-heating starts to be reduced (and goes to zero at approximately 7 minutes). As the hydrocarbon fuel (hydrocarbon fuel mixture) combusts, it provides sufficient energy to the combustion zone to maintain the temperature above the 850° C. required for flameless oxidation (FLOX).

In the second shaded zone (reading from left to right), a drop in hydrocarbon fuel (hydrocarbon fuel mixture) supply was simulated. This lead to a rapid drop in temperature to approximately 900° C. and spike in the oxygen concentration to approximately 12%. To maintain the temperature above 850° C. and the oxygen concentration in the safe region of below 12%, auxiliary fuel was rapidly provided. The auxiliary fuel combusted under FLOX conditions, providing sufficient energy to the combustion zone to maintain a temperature above 850° C., and consuming sufficient oxygen to maintain the oxygen concentration below 12%.

In the third shaded zone (reading from left to right), hydrocarbon fuel (hydrocarbon fuel mixture) supply was stopped, due to the low mass flow of the hydrocarbon fuel supply.

Correspondingly, the supply to auxiliary fuel was increased.

Thus, the auxiliary fuel is used to preheat the combustion zone to a temperature above 800° C. before the hydrocarbon fuel mixture is introduced. Once the minimum temperature of 800° C. is reached the start-up burner is switched from flame mode (start-up mode) to flox (flameless oxidation) mode and flameless combustion is established. In flameless combustion mode the auxiliary fuel is used to maintain the furnace temperature above 800° C. during times when the levels of hydrocarbon fuel mixture are decreased or zero (completely ceased), maintaining the furnace temperature at a constant level,

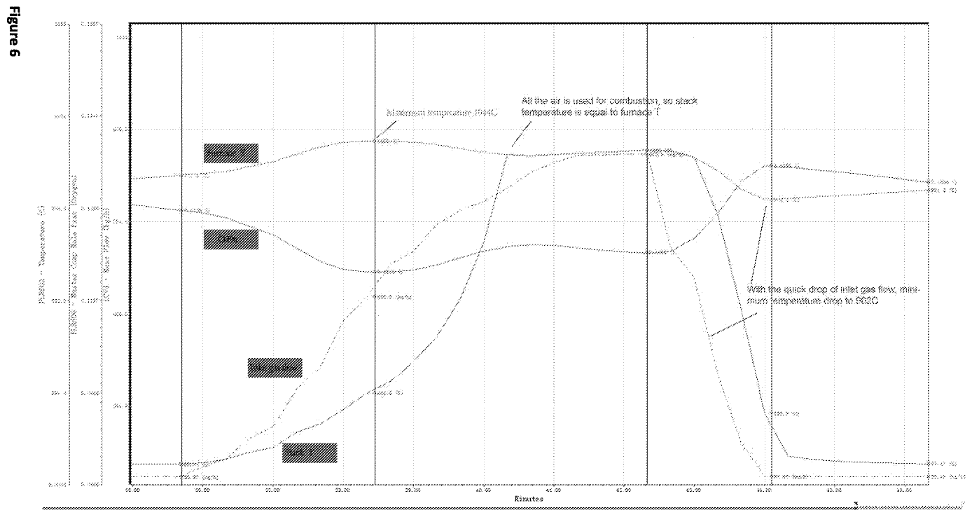

FIG. 5 depicts the simulated variation of combustion zone temperature and O₂ concentration by volume under simulated of the start of off gas feeding to the combustion chamber in the furnace.

The x-axis is time in minutes, from 3575 to 3640 minutes in graduations of 5 minutes. There are four y-axes, which read from left to right, are as follows:
1. hydrocarbon fuel mass flow (“LCV4” in kg/h), 0 to 1260 kg/h in graduations of 252 kg/h;
2. Computed mole fraction O₂ from 0.0250 to 0.160, in graduations of 0.0250;
3. Auxiliary fuel mass flow (propane, denoted “Fuel206”, in kg/h), from 0 to 20 kg/h, in graduations of 4 kg/h; and
4. Temperature of the combustion zone (° C.), 0 to 1500° C., in graduations of 300° C. The lines, starting from top to bottom as they intersect the y-axis, are as follows:
a. Temperature, with a starting value of 900° C.;
b. Auxiliary fuel flow rate, with an initial value of 3.1 kg/h;
c. Computed mole fraction O₂, with an initial value of 5%; and
d. Hydrocarbon fuel mass flow, with an initial value of 0.

A rapid increase in hydrocarbon fuel supply was simulated (at approximately 3568 minutes), from 0 to 950 kg/h. This is representative of opening a value to a partially filled hydrocarbon storage tank at ambient temperatures. The rapid provision of hydrocarbon fuel (hydrocarbon fuel mixture) leads to a rapid increase in temperature of the combustion zone to 1030° C., a rapid switch off of auxiliary fuel supply, and a rapid increase in oxygen concentration from around 5% to around 12%. A rapid stop in hydrocarbon fuel (hydrocarbon fuel mixture) supply was simulated (at approximately 3595 minutes, zone A), from 950 kg/h to 0. This is representative of closing a value to a partially filled hydrocarbon storage tank at ambient temperatures. The rapid cessation of the provision of hydrocarbon fuel (hydrocarbon fuel mixture) leads to a rapid decrease in temperature of the combustion zone from approximately 1000° C. to below 850° C. and a rapid increase in oxygen concentration from around 12% to around 14%. This occasioned an almost instantaneous switch-on of auxiliary fuel supply at around 3595 minutes, resulting in a very short-lived period where the temperature dipped below 850° C. of approximately 120 s. This is much shorter than comparable methods, and this method correspondingly results in far less NOₓ generation. Thus, by providing a short burst of auxiliary fuel, the combustion temperature can be quickly raised back to operational levels, ensuring a stable and continuous combustion process.

FIG. 6: depicts the simulated variation of combustion zone temperature and O₂ concentration by volume versus off gas hydrocarbon fuel mixture upon drop out of hydrocarbon fuel mixture off gas flow and incoming auxiliary fuel, such as LPG gas.

The x-axis is time in minutes, from 3575 to 3640 minutes in graduations of 5 minutes. There are four y-axes, which read from left to right, are as follows:
1. Temperature of: (i) the combustion zone (° C.) in the furnace; and (ii) the stack (° C.), from 0 to 1455° C., in graduations of 291° C.;
2. Computed mole fraction O₂ from 0.090 to 0.160, in graduations of 0.016; and
3. Hydrocarbon fuel mass flow (“LCV4” in kg/h), 0 to 1260 kg/h in graduations of 252 kg/h.

The lines, starting from top to bottom as they intersect the y-axis, are as follows:
a. Temperature of the combustion zone (“Furnace T”);
b. Computed mole fraction O₂, with an initial value of approximately 0.128;
c. Temperature of the stack (“Stack T”); and
d. Hydrocarbon fuel mass flow, with an initial value of 0.

### LIST OF REFERENCE NUMERALS

1 Flameless combustion apparatus
2 Furnace
3 Combustion zone
4 First injection port
5 First nozzle configured to allow injection of a first hydrocarbon fuel mixture
6 Second injection port
7 Means of measuring a combustion temperature, such as a thermocouple
8 Exhaust port
9 Fan
10 Valve
11 Solenoid valve
12 Air inlet filter
13 Flap for cooling air
14 Actuator motor
15 Pressure switch
16 Filter
17 Ball valve
18 Solenoid with pressure reducer
19 Valve
20 First FLOX burner
21 Second FLOX burner
22 Start-up burner capable of operating under FLOX and flame combustion conditions
23 Oxygen sensor
24 Flap
25 Linear flow control
26 Air
27 Hydrocarbon fuel (hydrocarbon fuel mixture)
28 Exhaust gas
29 Auxiliary fuel

### EXAMPLES

The following, non-limiting examples illustrate the products and processes according to the disclosure.

### Example 1—Process Simulation of a Method According to the Present Disclosure

An apparatus according to FIG. 3 was used in the simulation. The simulation was based on the schematic set up of FIG. 1. Mixtures of off gas and air under minimum, low, average and maximum conditions as detailed in Table 1 were used to model the performance of the method according to the first aspect of the invention, using an apparatus according to the second aspect of the invention.

The lower heating values for the minimum and low mixtures are calculated as 5.5 and 7.7 MJ/Nm³, respectively. The Heat- and Mass-Balance (H&M Balance) for the average case of Table 1 was calculated. It was determined that starting with 6.6 kmol/hr of LCV gas (=air-hydrocarbon off gas mixture from tank, see Table 1) 12.9 kmol/hr cold air is required for temperature control and oxygen supply. In effect the total furnace is operating at 10% v O₂, which is a safe oxygen content for any sudden variation in hydrocarbon content. Combustion temperature is estimated at 1000° C.

The maximum case has been simulated resulting in a calculated H&M Balance. It was determined that with 26.4 kmol/hr tank off gas mixture 110.6 kmol/hr cold air is required for temperature control and oxygen supply. Also for this case we estimate the effective combustion temperature at 1000° C.

It is estimated that the method according to the first aspect results in NOₓ emissions of less than 25 mg/Nm³ and less than 12 parts per million volume (ppmv). It is estimated that when the method is performed wherein the furnace oxygen concentration is maintained at from 3% to 12% by volume, this results in: (i) NOₓ emissions less than 25 mg/Nm³ and less than 12 ppmv; (ii) CO emissions under 20 mg/Nm³ and less than 16 ppmv; and (iii) total organic compound emissions of less than 2 mgC/Nm³ and less than 4 ppmv.

TABLE 1
Tank off gas - gas flow and composition.

| Component | Minimum | Low | Average | Maximum | Units |
|---|---|---|---|---|---|
| C1-C2 | 0.0 | 0.4 | 4.7 | 12.5 | kg/hour |
| C3-C5 | 0.0 | 1.0 | 12.6 | 86.5 | kg/hour |
| Total | 0.0 | 1.4 | 17.3 | 99 | kg/hour |
| Air | 0.0 | 14 | 176 | 700 | kg/hour |
| Total Flow | 0.0 | 15.4 | 193.3 | 799 | kg/hour |

### Example 2—Dynamic Process Simulation of a Method According to the Present Disclosure

In view of the high flow variations that are characteristic for tank off gas flow patterns [FIG. 2], a series of dynamic simulations were performed to quantify the system response upon rapid changes in off gas feed flow.

Key elements of respective parts of the extended Process Flow Diagram (PFD), are as follows:
1. The tank off gas feed system includes a gas pressure booster and flow control. In our simulations we have worked on basis of an initial pressure (ex-tank) of 103 kPa, to be adjusted to actual level.
2. The auxiliary fuel i.e. a gas, which can be Propane or LPG (optionally Natural Gas, NG, can be used), ensures fuel control for the step of preheating a combustion zone to above 800° C. and supplementary fuel addition in case of very lean off gas composition and for maintaining furnace temperature above 800° C. during zero flow.
3. The oxidant was selected from combustion air. The supply of fresh air was controlled for: (i) combustion; (ii) O₂ concentration and (iii) for temperature control.
4. The burner section and combustion chamber in the furnace included a set of 8 hydrocarbon fuel mixture gas burners (FIG. 3). Each burner was modelled as having a minimum capacity of 45 kg/hr and a maximum capacity of 140 kg/hr. In addition, one start-up burner was modelled for pre-heating the combustion chamber to above 800° C. from cold start-up or for providing additional heat to maintaining the temperature above 850° C. during flameless combustion. For the zero flow cases two additional Propane or LPG probes were modelled. For the dynamic simulation only the 8 LCV gas burners are relevant.
5. The dynamics of the unit operation were simulated with a continuous change of the inlet gas flow from 50 to 910 kg/hr, increase from 50 to 910 kg/hr within 5 minutes, followed by a sudden decrease of the inlet flow back to 50 kg/hr, drop to 50 kg/hr within 1 minute.
6. In FIG. 5 the system response over a period of 10 minutes is plotted. For key parameters like furnace temperature and O₂ concentration in flue gas we see changes as follows:
   with the rapid flow increase the O₂ concentration varies between 12.9% v (initial) and 11.7% v (lowest point), while the combustion zone temperature varies between 977 and 1044° C., both well under control; and
   with the sudden drop in hydrocarbon fuel mixture inlet gas flow, we calculated that the combustion zone temperature briefly decreased to 902° C., while the oxygen concentration goes up to 13% by volume followed by a coming down to 12% by volume in the subsequent stabilization. The full dynamics show an effective control of the key parameters for the combustion chamber, with that ensuring full and stable combustion through the whole sweep of hydrocarbon fuel mixture gas inflow from low to high and back to low.

In an analogous simulation over a longer period (65 minutes) the impact of zero off gas flow in combination with incoming auxiliary fuel gas (LPG in our example) was analysed. As is shown in FIG. 6 with the incoming LPG gas the combustion zone temperature is well controlled within the requirements of the method. In response to reduction of air supply for controlling the combustion zone temperature (reduction of flow due to lower furnace temperature) the O₂ level in the combustion chamber can drop to 5% by volume, which is still in the right window for full combustion under flameless combustion conditions. Hence, the present method, when optionally comprising the step in which the temperature of the furnace is maintained at a temperature of from 850 to 1200° C. by introducing an auxiliary fuel to the furnace is simulated as advantageously allowing for flameless combustion that can endure temporary supply shocks of the hydrocarbon fuel mixture without emitting undesirably levels NOₓ or CO.

1. A flameless combustion apparatus (1) for flameless combustion comprising:
a furnace (2) comprising a combustion zone (3);
at least one FLOX burner (20), the FLOX burner comprising a first injection port (4), the first injection port (4) comprising a first nozzle (5) configured to allow injection of a first hydrocarbon fuel mixture and a second nozzle configured to allow injection of an oxidant;
at least one start-up burner (22) capable of operating under FLOX and Flame combustion conditions comprising a second injection port (6), the second injection port (6) comprising a third nozzle configured to allow injection of a first auxiliary fuel and a fourth nozzle configured to allow injection of an oxidant;
a means of measuring a combustion temperature (7); and
an exhaust port (8);
wherein the first and second nozzles are arranged in parallel so as to allow provision of the first hydrocarbon fuel mixture and oxidant to the FLOX burner; and
wherein the third and fourth nozzles are arranged in parallel so as to allow provision of the first auxiliary fuel- and optionally oxidant to a start-up burner.

2. The flameless combustion apparatus according to claim 1, wherein the second injection port and furnace are configured to allow flameless combustion of the first auxiliary fuel with an exhaust gas recirculation rate of from 0 to 0.5.

3. A method of flameless combustion in a flameless combustion apparatus according to any of claims 1-2, comprising:
(i) preheating a combustion zone to above 800° C.;
(ii) maintaining the temperature of the combustion zone at a temperature between 850° C. and 1400° C.;
(iii) simultaneously injecting an oxidant and a hydrocarbon fuel mixture into the combustion zone, wherein the oxidant and the hydrocarbon fuel mixture are injected independently of each other from respective first and second locations
(iv) combusting the hydrocarbon fuel mixture without flames; and
(v) venting exhaust gasses,
wherein the hydrocarbon fuel mixture combusts without flames by maintaining a furnace oxygen concentration of the combustion zone below 12% by volume and maintaining an exhaust gas recirculation rate of from 0 to 0.5.

4. The method according to claim 3, in which the oxidant is pre-heated before injection into the combustion zone.

5. The method according to claims 3-4, in which the hydrocarbon fuel mixture is pre-heated before injection into the combustion zone.

6. The method according to any preceding claim, wherein the hydrocarbon fuel mixture is selected from a boil-off gas, a residual gas or liquid, a hydrocarbon storage purge gas or any combination thereof.

7. The method according to any preceding claim, in which the temperature of the furnace is maintained at a temperature of from 850 to 1200° C. by either:
Introducing air with a temperature of below 40° C. to the furnace; and/or
Introducing an auxiliary fuel to the furnace.

8. The method according to any preceding claim, wherein the furnace oxygen concentration is maintained at from 3% to 12% by volume, preferably from 3% to 10% by volume.

9. The method according to any preceding claim, wherein the furnace temperature is maintained at a temperature of from 800-1400° C., preferably of from 850 to 1200° C., more preferably of from 900-1100° C.,

10. The method according to any preceding claim, wherein the method comprises a first step of pre-heating the combustion zone to above 800° C. using an auxiliary fuel.

11. The method according to any preceding claim, wherein the auxiliary fuel is selected from methane, ethane, propane, butane, natural gas, any other hydrocarbon or flammable gaseous feed or any combination thereof, more preferably selected from methane, ethane, propane, butane, natural gas, any other hydrocarbon, hydrogen or any combination thereof, most preferably selected from methane, ethane, propane, butane.

12. The method according to any preceding claim, wherein the (pre-heated) oxidant is introduced to the oxidation zone at a velocity of at least 40 m/s, preferably at a velocity of at least 50 m/s.

13. The method according to any preceding claim, wherein the first hydrocarbon fuel mixture is introduced to the oxidation zone at a velocity of at least 40 m/s, preferably at least 50 m/s

14. The method according to any preceding claim, wherein the first hydrocarbon fuel mixture is provided to the combustion zone at 0.8 to 50 megajoules per normal cubic metre (MJ/Nm3), preferably 1.0 to 30 MJ/Nm3, more preferably 1.5 to 20 MJ/Nm3.

15. The method according to claim 11 wherein the method comprises a step of providing the auxiliary fuel during instances of rapid decrease in hydrocarbon fuel mixture levels or complete hydrocarbon fuel mixture cessation.

16. A method for combusting Boil-Off Gas (BOG) comprising hydrocarbons, the method comprising:
collecting BOG comprising at least one hydrocarbon from at least one hydrocarbon storage tank;
delivering the collected BOG to a combustion apparatus, preferably flameless combustion apparatus according to claim 1, suitable for performing the method of any of claims 3-15; and
combusting the BOG under flameless conditions according to a method according to any of claims 3-15.

17. A method for combusting Residual Gas and/or Liquid (RGL) comprising hydrocarbons, the method comprising:
bringing a hydrocarbon storage tank into fluid communication with a combustion apparatus, preferably flameless combustion apparatus according to claim 1, suitable for performing the method of any of claims 3-15;
delivering a gas comprising residual gas and/or liquid from the hydrocarbon storage tank to the combustion apparatus, preferably the flameless combustion apparatus;
controlling the supply of residual gas and/or liquid to the combustion zone to maintain a temperature above 850° C. so as to maintain flameless combustion in the combustion zone,
when the maximal supply of residual gas and/or liquid to the combustion zone of the combustion apparatus becomes insufficient to maintain a temperature of above 850° C., providing auxiliary fuel to the combustion zone of the combustion apparatus and combusting both: (i) the auxiliary fuel; and (ii) the residual gas and/or liquid under flameless conditions according to any of claims 3-15.

18. The method according to claim 17, wherein the method comprises the additional step of:
purging the hydrocarbon storage tank with an inert gas, the purging gas being preferably selected from nitrogen, argon or mixture thereof and delivering the hydrocarbon comprising purging gas to the combustion apparatus, preferably flameless combustion apparatus;
when the temperature of the combustion zone of the combustion apparatus exceeds 850° C., introducing the hydrocarbon comprising purging gas to the combustion zone to combust the hydrocarbons within the purging gas under flameless conditions according to a method according to claims 3-15
controlling the supply of hydrocarbon comprising purging gas to the combustion zone to maintain a temperature above 850° C. so as to maintain flameless combustion in the combustion zone; and
when the maximal supply of purging gas to the combustion zone of the combustion apparatus becomes insufficient to maintain a temperature of above 850° C., providing auxiliary fuel to the combustion zone of the combustion apparatus and combusting both: (i) the auxiliary fuel; and (ii) the hydrocarbons of the purging gas under flameless conditions according to method according to claims 3-15.

19. A system for flameless combustion, comprising
at least one hydrocarbon storage tank and a flameless combustion apparatus according to claim 1, the flameless combustion apparatus comprising
a furnace with a combustion chamber and a combustion zone;
at least one FLOX burner, the FLOX burner comprising a first injection port, the first injection port comprising a first nozzle configured to allow injection of a first hydrocarbon fuel mixture and a second nozzle configured to allow injection of an oxidant;
at least one start-up burner capable of operating under FLOX and Flame combustion conditions comprising a second injection port, the second injection port comprising a third nozzle configured to allow injection of a first auxiliary fuel and a fourth nozzle configured to allow injection of an oxidant;
a means of measuring a combustion temperature; and
an exhaust port;
wherein the first and second nozzles are arranged in parallel so as to allow provision of the first hydrocarbon fuel mixture and oxidant to the FLOX burner; and
wherein the third and fourth nozzles are arranged in parallel so as to allow provision of the first auxiliary fuel and optionally oxidant to a start-up burner,
wherein the at least one hydrocarbon storage tank is connected to the flameless combustion apparatus by means allowing the at least one hydrocarbon storage tank to be brought into fluid communication with the flameless combustion apparatus.

20. The system for flameless combustion, according to claim 19, wherein the second injection port and furnace are configured to allow flameless combustion of the first auxiliary fuel with an exhaust gas recirculation rate of from 0 to 0.5.

21. The system for flameless combustion according to claim 20, further comprises an intermediate storage tank, means to bring the hydrocarbon storage tank into a fluid communication with the intermediate storage tank, and means to bring the hydrocarbon storage tank into fluid communication with the flameless combustion apparatus, and/or means to bring the intermediate storage tank into fluid communication with the flameless combustion apparatus.

22. Use of the system for flameless combustion according to claim 21 or flameless combustion apparatus according to claim 1, for degassing a hydrocarbon storage tank, the hydrocarbon storage tank being part of the system for flameless combustion.

23. Use of the system for flameless combustion according to anyone of claims 21-22 for degassing a hydrocarbon storage tank of a ship.

24. A method for degassing a hydrocarbon storage tank within the system for flameless combustion according to claims 21-23, wherein the method comprises the following steps:
pumping out any liquid from the hydrocarbon storage tank until less than 5% of the hydrocarbon storage tank by volume is filled with hydrocarbon liquid;
bringing the hydrocarbon storage tank of vessel into fluid communication with the intermediate storage tank;
vaporizing residual hydrocarbon liquid in the hydrocarbon storage tank;
allowing vapourised hydrocarbon to move from the hydrocarbon storage tank to the intermediate storage tank;
optionally condensing and/or compressing vapourised hydrocarbon in the intermediate storage tank;
delivering at least a primary portion of the vaporized, condensed, and/or compressed hydrocarbon from the intermediate storage tank to a flameless combustion apparatus configured to perform the method of flameless combustion according to anyone of claims 3-15, and/or facilitating an export of a secondary portion of the condensed hydrocarbon,
purging the hydrocarbon storage tank subsequent to removal of the residual hydrocarbon liquid in the preceding steps with an inert gas, such as nitrogen, argon, or a mixture thereof;
delivering the hydrocarbon comprising purging gas from the hydrocarbon storage tank to: (i) the intermediate storage tank, and/or (ii) a flameless combustion apparatus adapted to perform the method according to anyone of claims 3-15;
delivering at least some of the purging gas comprising the hydrocarbon to the flameless combustion apparatus;
when the temperature of the combustion zone of the flameless combustion apparatus exceeds 850° C., combusting the gas delivered to the apparatus under flameless conditions according to a method according to anyone of claims 3-15;
controlling the supply of hydrocarbon comprising purging gas to the combustion zone to maintain a temperature above 850° C. so as to maintain flameless combustion in the combustion zone; and
when the maximal supply of purging gas to the combustion zone of the flameless combustion apparatus becomes insufficient to maintain a temperature of above 850° C., providing auxiliary fuel to the combustion zone of the combustion apparatus and combusting both: (i) the auxiliary fuel; and (ii) the hydrocarbons of the purging gas under flameless conditions according to method according to anyone of claims 3-15.
